(19) United States
(12) Patent Application Publication
(10) Pub. No.: US 2013/0099569 A1
(43) Pub. Date: Apr. 25, 2013

(54) CHARGING CONTROL METHOD

(71) Applicants: Ting-Wei Hsu, Taipei City (TW); Chien-Hung Chen, Taipei City (TW); Chang-Yuan Wu, Taipei City (TW)

(72) Inventors: Ting-Wei Hsu, Taipei City (TW); Chien-Hung Chen, Taipei City (TW); Chang-Yuan Wu, Taipei City (TW)

(21) Appl. No.: 13/654,426

(22) Filed: Oct. 18, 2012

Related U.S. Application Data
(60) Provisional application No. 61/550,469, filed on Oct. 24, 2011.

(51) Int. Cl. H02J 7/00

(52) U.S. Cl. 307/31

(57) ABSTRACT

A charging control method adapted to be used in a portable electronic device is provided. The portable electronic device includes a display module and a rechargeable battery. The charging control method includes the following steps. Firstly, a working status of the display module is obtained and a control signal is transmitted by a control unit. Next, the control signal is received and a charging power provided to the rechargeable battery is adjusted according to the control signal by a power control unit.

### CROSS-REFERENCE TO RELATED APPLICATION

This application claims the priority benefits of U.S. provisional application Ser. No. 61/550,469, filed on Oct. 24, 2011. The entirety of the above-mentioned patent application is hereby incorporated by reference herein and made a part of this specification.

### BACKGROUND

1. Field of the Invention

The invention relates to a charging control method.

2. Description of Related Art

Following advances in technology, all kinds of electronic products are developing towards a tendency of high-speed, high-performance and compact size. Hence, all kinds of portable electronic devices, such as notebook computer, tablet PC and Smartphone, gradually become mainstreams of the market. In order to facilitate product uses for users under an environment absent of power supply, every portable electronic device is often disposed with a rechargeable battery therein. In a process of charging the rechargeable battery of the portable electronic device, in order to shorten a charging time, a maximum fixed current is often applied to perform the charging.

However, a temperature of an outer casing of the portable electronic device is raised due to heat generated by the portable electronic device generates during the process of charging. A display module of the portable electronic device also generates heat during the operation, and thus the temperature of the outer casing of the portable electronic device is raised. When the portable electronic device is being charged with the maximum current and the display module of the portable electronic device is constantly operated, it is likely to cause the temperature of the outer casing of the portable electronic device being too high, and thereby arouses a discomfort feeling in the user.

### SUMMARY OF THE INVENTION

The invention provides a charging control method capable of enabling a portable electronic device to be maintained at an appropriate temperature during charging, and to maintain a charging efficiency thereof.

The invention provides a charging control method adapted to be used in a portable electronic device. The portable electronic device has a display module and a rechargeable battery. The charging control method includes the following steps. Firstly, a working status of the display module is obtained and a control signal is transmitted by used a control unit. Next, the control signal received and a charging power provided to the rechargeable battery is adjusted according to the control signal by a power control unit.

According to the foregoing, in the invention, the working status of the display module is obtained via the control unit, and then the charging power provided to the rechargeable battery is adjusted according to the working status via the power control unit, so as to avoid a temperature of an outer casing of the portable electronic device from being too high. In addition, the charging power provided to the rechargeable battery may further be adjusted by detecting whether the portable electronic device is in idle. When the charging power is a charging current and when the portable electronic device is already being in idle for a preset amount of time, then the control unit and the power control unit (for example a current control unit) adjust a current value of the charging current to a maximum current value in order to accelerate a charging speed of the rechargeable battery. Therefore, under a circumstance of maintaining a certain charging efficiency, the invention may avoid a problem of having the temperature of the outer casing of the portable electronic device being too high in a process of charging due to operations of the display module and the portable electronic device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a charging control method according to an embodiment of the invention.

FIG. 2 is a flow chart illustrating a charging control method according to another embodiment of the invention.

FIG. 3 is a block diagram illustrating a portable electronic device according to an embodiment of the invention.

### DETAILED DESCRIPTION OF DISCLOSED EMBODIMENTS

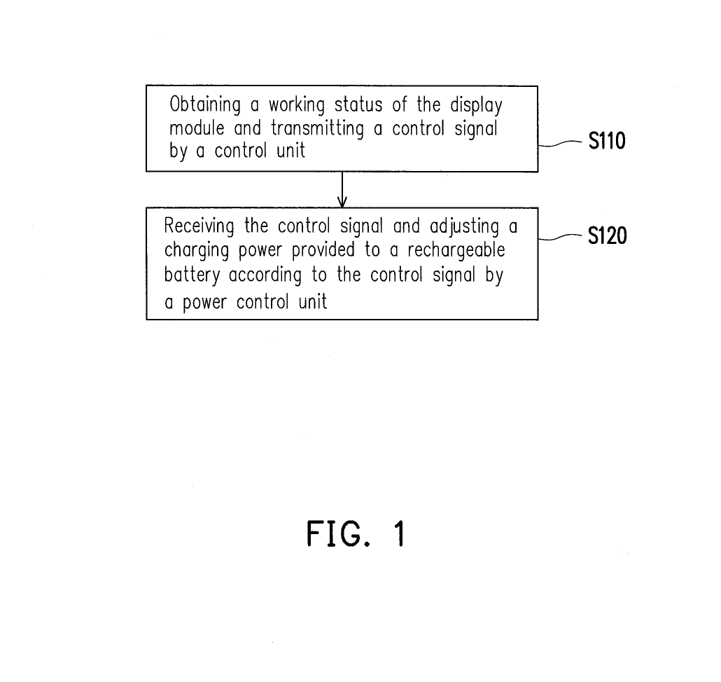

FIG. 1 is a flow chart illustrating a charging control method according to an embodiment of the invention. The charging control method of the present embodiment may adapt to be used in a portable electronic device, and the portable electronic device has a display module and a rechargeable battery, whereon the display module may be a liquid crystal display module or a plasma display module. In the embodiment of the invention, the display module is a liquid crystal display module, but the scope of the invention is not limited thereto. The charging control method of the present embodiment includes the following steps. Firstly, in step S110, a working status is obtained by a control unit. The working status of the display module may be detected via a detection unit, and then the result is transmitted to the control unit by the detection unit so as to perform the subsequent processing. With differences in product design, the control unit may directly obtain the status of the display module without going though the detection unit, but the scope of the invention is not limited thereto. Next, the step S120 is executed, the control unit, via a power control unit, adjusts a charging power provided to a rechargeable battery according to the working status of the display module obtained in step S110, wherein the charging power may be a charging current provided to the rechargeable battery or a charging voltage provided to the rechargeable battery; in the embodiment of the invention, the charging power is a charging current of the rechargeable battery, but the scope of the invention is not limited thereto. The working status of the display module obtained by the control unit may be parameters presented by the display module, such as a brightness value, a saturation degree, a gray scale value or so forth. In the embodiment of the invention, the detected working status of the display module is a brightness value of the display module, but the scope of the invention is not limited thereto.

For example, when the brightness value of the display module is in between a brightness range, such as from 60% to 100%, the control unit adjusts a current value of the charging current to 512 milliamperes via the current control unit. When the brightness value of the display module is in between another brightness range, such as 30% to 59%, the control unit adjusts a current value of the charging current to 768 milliamperes via the current control unit. When the brightness value display module is in between yet another brightness range, such as from 0% to 29%, the control unit adjusts a current value of the charging current to 896 milliamperes via the current control unit. If the working status of the display module is OFF, the control unit adjusts a current value of the charging current to 1024 milliamperes via the current control unit. When the display module is already being OFF for a preset amount of time (e.g., 10 minutes), the control unit adjusts a current value of the charging current to a maximum value (e.g., 1024 milliamperes) via the current control unit. The brightness values and the current values mentioned-above are merely examples taken to facilitate the understanding of the concepts of the invention, and are not intended to limit the scope of the invention.

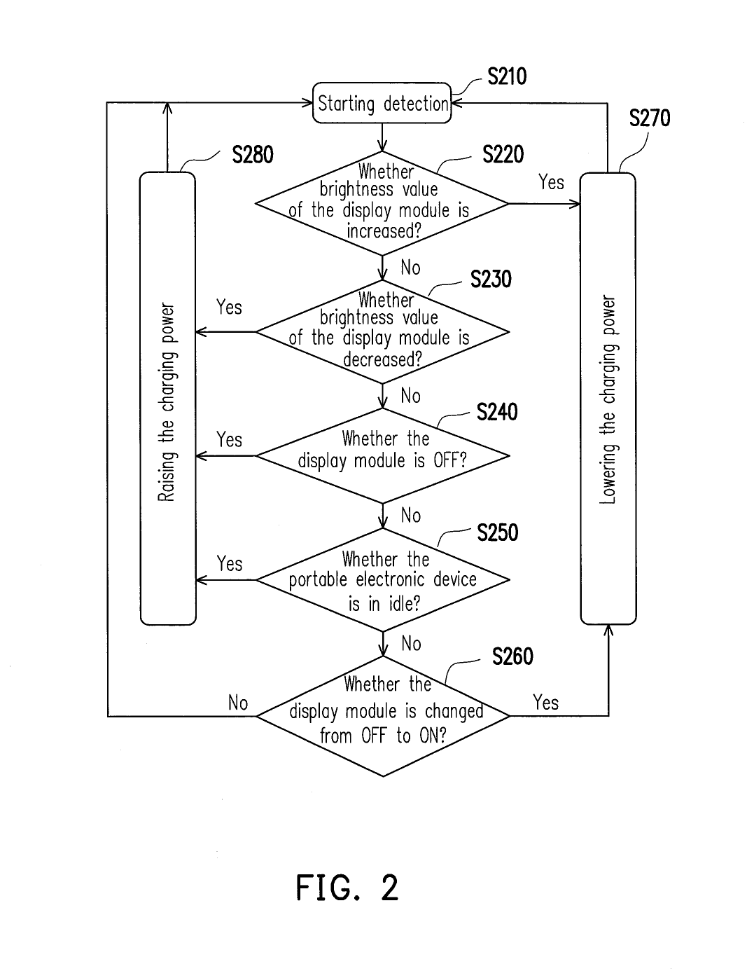

FIG. 2 is a flow chart illustrating a charging control method according to another embodiment of the invention. The embodiment illustrated in FIG. 2 is more specific than the embodiment illustrated in FIG. 1. Referring to FIG. 2, the step S220 is executed, the control unit determines whether the brightness value of the display module is increased. If the brightness value is increased, then the step S270 is executed, so that the current value of the charging current is decreased. If not, then the step S230 is executed, the control unit determines whether the brightness value of the display module is decreased. If the brightness value is decreased, then the step S280 is executed, so that the current value of the charging current is increased. If not, then it is apparent that the brightness value is neither increased nor decreased, and the step S240 is executed, the control unit determines whether the display module is OFF. If yes, then the step S280 is executed, the current value of the charging current is increased. If not, it is apparent that the working status of the display module has not changed, namely, the brightness value of the display module is neither changed nor OFF, then the step S250 is executed, the control unit determines whether the portable electronic device is in idle. If yes, then the step S280 is executed, the current value of the charging current is increased. If not, then the step S240 is executed, the control unit determines whether the display module is switched from OFF to ON. If yes, then the step S270 is executed, the current value of the charging current is decreased. If not, then again back to the step S210, the control unit determines the working status of the display module.

As the charging control method described above, the control unit may adjust the charging power provided to the rechargeable battery according to the working status of the display module and the portable electronic device via the power control unit. IF the adjusted charging power is a charging current, then the current value of the charging current provided to the rechargeable battery may be increased or decrease according to the working status of the display module. As a result, not only that a problem of having a temperature of an outer casing of the portable electronic device being too high in a process of charging due to operations of the display module and the portable electronic device may be avoided, a certain charging efficiency may also be maintained.

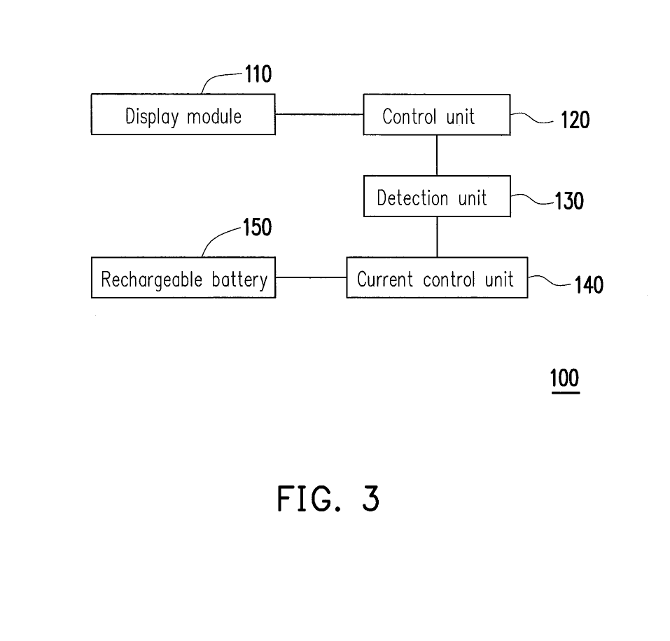

FIG. 3 is a block diagram illustrating a portable electronic device according to an embodiment of the invention. Referring to FIG. 3, the charging methods described in the above-mentioned embodiments are adapted to be used in a portable electronic device 100; in the present embodiment, the portable electronic device 100 may be a notebook computer or a tablet PC, but the invention does not limit the types of the portable electronic device. The portable electronic device 100 includes a display module 110, a control unit 120, a detection unit 130, a power control unit and a rechargeable battery 150, wherein along with different product demands, the power control unit may be a current control unit or a voltage control unit. In the embodiment of the invention, the power control unit is a current control unit 140, but the scope of the invention is not limited thereto. The control unit 120 is coupled to the display module 110 and can control a working status of the display module 110. The detection unit 130 is coupled to the control unit 120 and can detect the working status of the display module 110; namely, the working status of the display module 110 may be obtained via the control unit 120. The current control unit 140 is coupled to the control unit 120 and can adjust a current value of the charging current according to an adjustment signals transmitted to the control unit 120 based on the working status detected by the detection unit 130. The rechargeable battery 150 is coupled to the current control unit 140 and can receive the charging current to perform charging. The control unit 120 may be an embedded controller, and the current control unit may be a charger, but the scope of the invention is not limited thereto. If the current control unit is a charger, then the current control unit may further be used to control a charging voltage. With differences in product design, the working status of the display module 110, after being detected by the detection unit 130, may be transmitted by the detection unit 130 to the control unit 120 so as to perform subsequent processing. The working status of the display module 110 may also be directly obtained by the control unit 120 without going through the detection unit 130. In the embodiment of the invention, the working status of the display module 110 is firstly detected by the detection unit 130 and then transmitted to the control unit 120, but the scope of the invention is not limited thereto.

According to the foregoing, if the working status detected by the detection unit 130 is a brightness value of the display module 110, then the control unit 120 generates a control signal according to the brightness value, and the current control unit 140 adjusts the current value of the charging current according to the control signal. In the present embodiment, the display module 110 has a display unit and a backlight module, and the brightness value is a brightness value of the backlight module. When the brightness value detected by the detection unit 130 is increased, the current control unit 140 decreases the current value of the charging current according to the control signal. When the brightness value detected by the detection unit 130 is decreased, the current control unit 140 increases the current value of the charging current according to the control signal. When the working status of the display module 110 detected by the detection unit 130 is OFF, the current control unit 140 increase the current value of the charging current according to the control signal.

For example, when the detection unit 130 detects that the brightness value of the display module 110 is in between a brightness range, such as from 60% to 100%, the current control unit 140 adjusts the current value of the charging current to 512 milliamperes according to the control signal transmitted from the control unit 120. When the detection unit 130 detects that the brightness value of the display module 110 is in between another brightness range, such as from 30% to 59%, the current control unit 140 adjusts the current value of the charging current to 768 milliamperes according to the control signal transmitted from the control unit 120. When the detection unit 130 detects that the brightness value of the display module 110 is in between yet another brightness range, such as from 0% to 29%, the current control unit 140 adjusts the current value of the charging current to 896 milliamperes according to the control signal transmitted from the control unit 120. When the detection unit 130 detects that the working status of the display module 110 is OFF, the current control unit 140 adjusts the current value of the charging current to 1024 milliamperes according to the control signal transmitted by the control unit 120. When the display module 110 is detected as being OFF for a preset amount of time (e.g., 10 minutes), the current control unit 140 adjusts the current value of the charging current to a maximum value (e.g., 1024 milliamperes) according to the control signals transmitted from the control unit 120. The above-mentioned brightness value and the current value are merely examples taken to facilitate the understanding of the concepts of the invention, and are not intended to limit the scope of the invention.

According to the foregoing, in the present embodiment, the brightness value detected by the detection unit 130 is neither increased nor decreased; namely, the working status has not changed, and then the control unit 120 further determines whether the portable electronic device 100 is in idle. When the control unit 120 determines that the portable electronic device 100 is already in idle for a present amount of time (e.g., 10 minutes), such that no action has been executed for more than 10 minutes, a control signal is transmitted to the current control unit 140, so as to adjust the current value of the charging current to a maximum current value, such as 1920 milliamperes. If the control unit 120 determines that the working status of the display module is switched from OFF to ON, the control unit 120 transmits the control signal to the current control unit 140 to lower the current value of the charging current.

As for the portable electronic device 100 described above, the control unit 120 may transmit the control signal according to the working status detected by the detection unit 130, and the current control unit 140 may adjust the current value of the charging current according to the control signal. Therefore, the current value of the charging current provided to the rechargeable battery 150 may be changed according to the working status of the display module 110 and a usage status of the portable electronic device 100. As a result, not only that a problem of having a temperature of an outer casing of the portable electronic device 100 being too high in a process of charging due to operations of the display module 110 and the portable electronic device 100 may be avoided, a certain charging efficiency may also be maintained.

In summary, in the invention, the working status of the display module is obtained via the control unit, and then the charging power provided to the rechargeable battery is adjusted according to the working status via the power control unit, so as to avoid the temperature of the outer casing of the portable electronic device from being too high. In addition, the charging power provided to the rechargeable battery may further be adjusted by detecting whether the portable electronic device is in idle. When the charging power is a charging current and when the portable electronic device is already being in idle for a preset amount of time, then the control unit and the power control unit (for example a current control unit) adjust the current value of the charging current to the maximum current value in order to accelerate a charging speed of the rechargeable battery. Therefore, under a circumstance of maintaining a certain charging efficiency, the invention may avoid the problem of having the temperature of the outer casing of the portable electronic device being too high in the process of charging due to the operations of the display module and the portable electronic device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A charging control method adapted to be used in a portable electronic device, the portable electronic device having a display module and a rechargeable battery, the charging control method comprising:
obtaining a working status of the display module and transmitting a control signal by a control unit; and
receiving the control signal and adjusting a charging power provided to a rechargeable battery according to the control signal by a power control unit.

2. The charging control method as recited in claim 1, wherein the charging power is a charging current or a charging voltage.

3. The charging control method as recited in claim 2, wherein the working status comprising a brightness value, a gray scale value or a saturation degree of the display module.

4. The charging control method as recited in claim 3, wherein the display module is a liquid crystal display module, the liquid crystal display module has a display unit and a backlight module, and the brightness value is a brightness value of the backlight module.

5. The charging control method as recited in claim 3, wherein when the brightness value increases, the power control unit lowers the charging power.

6. The charging control method as recited in claim 3, wherein when the brightness value decreases, the power control unit raises the charging power.

7. The charging control method as recited in claim 2, wherein the step of adjusting the charging power provided to the rechargeable battery further comprises:
raising the charging power by the power control unit when the working status of the display module is OFF.

8. The charging control method as recited in claim 2 further comprising:
determining whether the portable electronic device is in idle by the control unit when the working status has not changed; and
adjusting the charging power to a maximum charging power value when the portable electronic device is determined by the control unit as already being in idle for a preset amount of time.

9. The charging control method as recited in claim 2, wherein the step of adjusting the charging power provided to the rechargeable battery further comprises:
lowering the charging power by the power control unit when the working status of the display module is switched from OFF to ON.

10. The charging control method as recited in claim 3, wherein the steps of adjusting the charging power provided to the rechargeable battery comprise:
adjusting the charging power to a first charging power value when the brightness value is in between a first brightness range; and
adjusting the charging power to a second charging power value when the brightness value is in between a second brightness range,
wherein a minimum value of the first brightness range is greater than a maximum value of the second brightness range, and the first charging power value is smaller than the second charging power value.

11. The charging control method as recited in claim 10, wherein the step of adjusting the charging power provided to the rechargeable battery further comprises:
adjusting the charging power to a third charging power value when the working status of the display module is OFF, wherein the third charging power value is greater than the first charging power value and the second charging power value.
